(19) United States
(12) Patent Application Publication
(10) Pub. No.: US 2003/0033200 A1
(43) Pub. Date: Feb. 13, 2003

(54) FilmBox

(76) Inventor: Alan James Karl Scott, Tacoma, WA (US)

Correspondence Address: Alan James Karl Scott, 10025 So. Patterson St., Tacoma, WA, 98444, US

(21) Appl. No.: 10/083,090

(22) Filed: Feb. 26, 2002

Related U.S. Application Data
(60) Provisional application No. 60/271,348, filed on Feb. 26, 2001.

(51) Int. Cl. G06F 17/60

(52) U.S. Cl. 705/14

(57) ABSTRACT

The FilmBox is an improvement on various other forms of advertising by combining powerful television, poster and brochure advertising. It places them all together in a format that has not, until now been used. It solves the expense issue for small businesses trying to advertise by making it affordable yet professional and very visible. FilmBox is entertaining and holds the consumer captive in an otherwise dull situation; waiting in line.

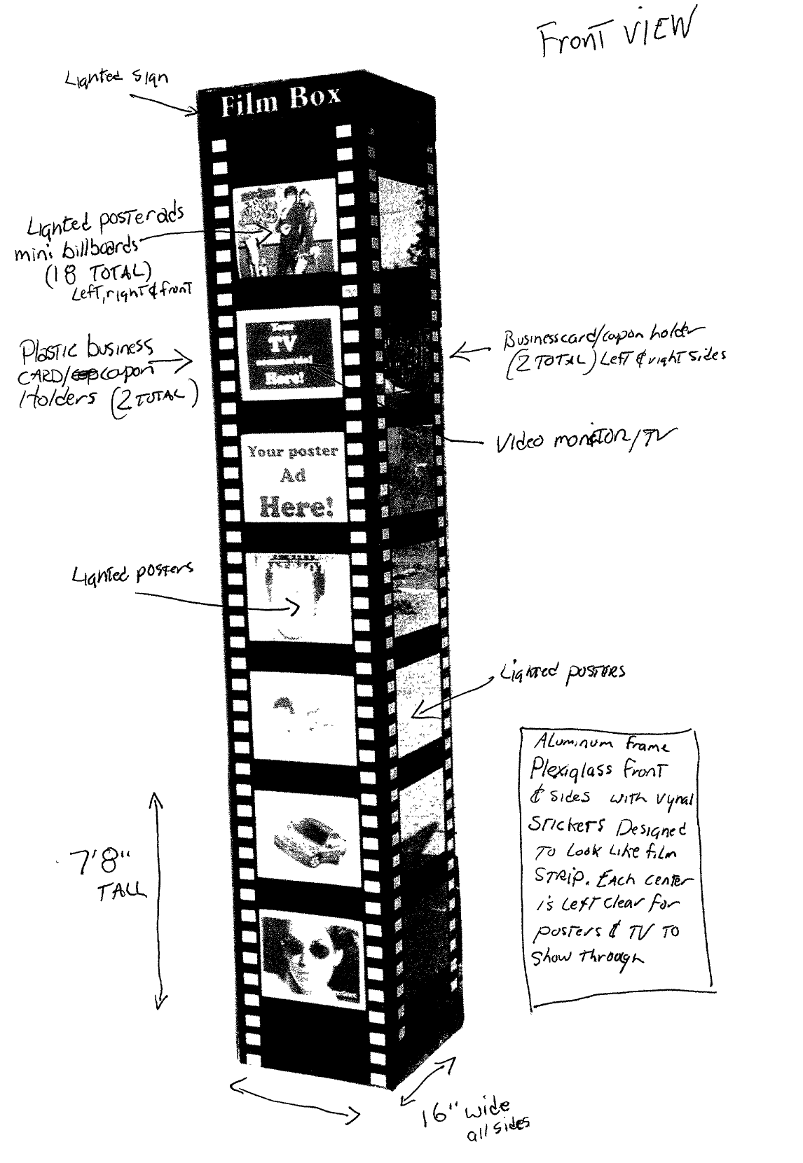

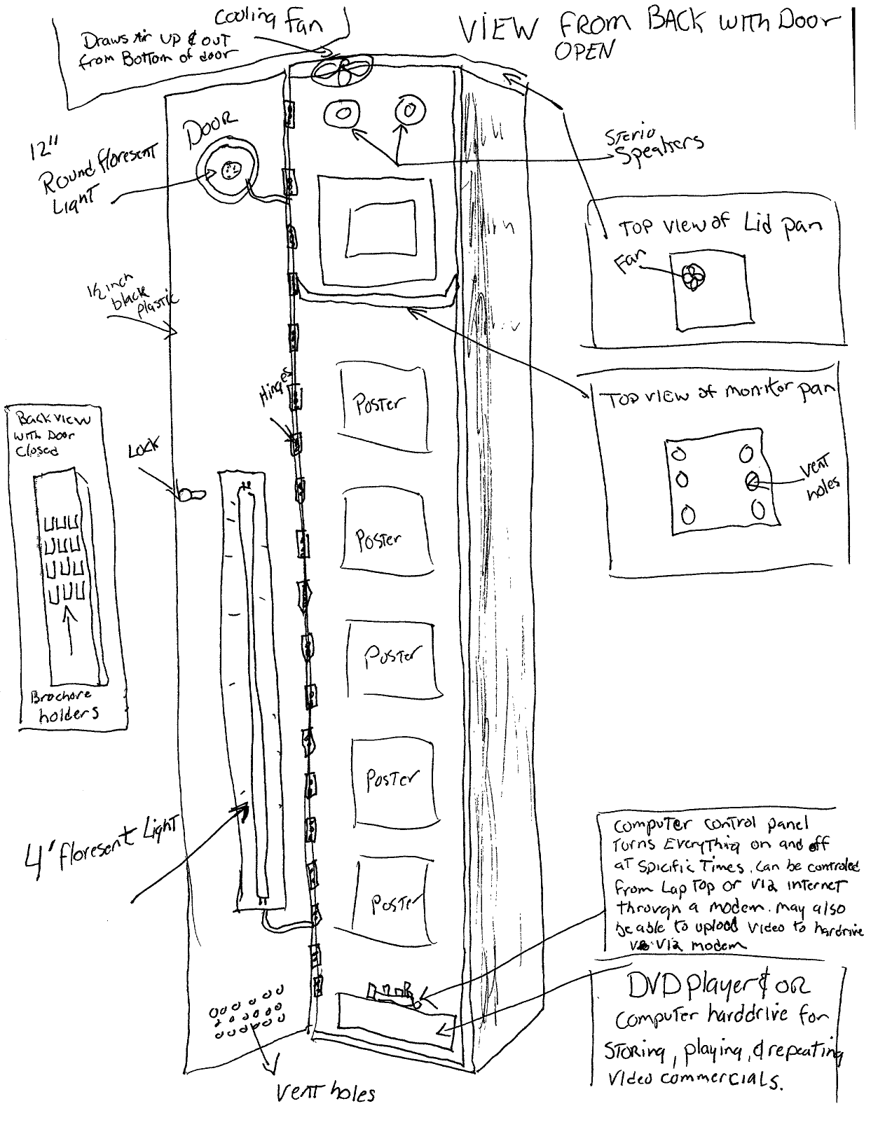

### BACKGROUND

Advertising would be the background. There are many problems with modern advertising that could be improved up on.

(1) All forms of advertising to some degree are simply a form of gambling since no advertiser can guarantee results from their form of advertising. The best they can do is increase the odds of their advertising. The better the odds of any given form of advertising the more that form costs.

(2) Most forms of advertising annoy or irritate the consumer. Mail order advertising clutters the consumer's mailbox with junk mail creating more time to go through your mail and also creating more trash to be disposed of. Radio advertising is a powerful expensive form of advertising that irritates the consumer by interrupting their favorite music or talk shows every ten minutes or less. Television advertising is also very expensive and interrupts the consumers favorite programs. It has become so irritating that the consumer is finding new ways to avoid seeing those ads. Up until recently the consumer only had just a few options to avoid a TV commercial. They could leave the room during the ad, change the channel with the remote or just ignore it all together by engaging in conversation with others during this time. Today there have been many new developments to avoid TV ads. Paid cable television like HBO or Showtime would be one of the first, but now there is satellite and dish television that can zap out ads in real time so you can watch your favorite show commercial free. There are even boxes now one can buy in the local department store that attach to your television to also zap out commercials in real time. New developments every day help the consumer avoid ads. Even your e-mail and Internet are not safe from ads but the market offers many different programs to eliminate even these forms of advertising with e-mail blockers and banner blockers.

(3) The cost of advertising is on the rise. Because the consumer is constantly trying to avoid advertising the risks involved in advertising grow, thus causing the business owner to spend more for less. The less the gamble the more it costs. The more you spend the higher your odds of reaching more people. Small and medium sized businesses cannot afford the better forms of advertising. This is why most of the TV and radio ads you hear and see are from larger companies.

### SUMMARY

(1) FilmBox was created to aid small and medium sized businesses eliminate the odds and high costs of advertising. FilmBox will improve upon most of the negative aspects of advertising by fixing the problems normally associated with advertising (see Background page 1-3.)

(2) Advertising is gambling because the advertiser does not know how many people will see their ad. The advertiser knows that the consumer will avoid their ad if possible. FilmBox is the solution to this problem. FilmBox will not only improve the odds of advertising but will also improve the costs involved with advertising by eliminating the irritating annoying factor involved with today's ads. FilmBox does not irritate the consumer by interrupting their daily routine. In fact FilmBox is a form of entertainment in a situation that would normally be considered boring.

(3) The design of the filmstrip is the most recognizable symbol in today's world; its black and white color is pleasing to the eye and goes with any décor. Its size being less than two square feet makes it easy to place anywhere. FilmBox is designed to be placed at movie theater popcorn stands, grocery check stands, department store check stands, doctor's office waiting areas, or anywhere the consumer would normally be waiting in line.

(4) Waiting in line at the bank or grocery store can be irritating to the consumer because it is waisted time and very boring. Five minutes could seem like an hour and in many cases a customer can become quite upset sometimes even walking out of the store or by never returning. FilmBox uses this situation to its advantage; we use the theories behind infomercials that have become a billion dollar industry. When infomercials started no one would of thought they could become successful by taking the otherwise known commercial and extending it to twenty minutes and longer but the secret wasn't in its length but it's placement. Infomercials always come on when there is nothing else on television, late at night or early morning when there is nothing to watch. When the consumer is bored with nothing to do. Now that irritating 20 minute long commercial becomes a form of entertainment, something to watch, information in a boring situation. Now FilmBox too uses that same theory in advertising. By showing informational ads from local businesses in a boring situation. FilmBox also shows bits of things to do in your neighborhood, events and news on a much more local level. The consumer can see upcoming events locally and see what specials businesses have to offer.

(5) Most ads on FilmBox offer discounts and coupons to the consumer. In many cases the consumer may not have a pen handy to write down a number or they forget that ad or number. FilmBox also has coupon, business card, and brochure holders on its kiosk. The consumer can take a coupon or card as a reminder of that ad or to simply redeem a coupon. Making it easy for the advertiser to keep track of customers that see their ad on FilmBox.

(6) There are eighteen posters and approximately eighteen commercials that show over and over on the FilmBox throughout the day, each ad showing once every eight-nine minutes. Which means that almost every consumer will see your ad while waiting in line. They cannot change the channel or walk away they are completely captive and they don't mind because it is not irritating it is entertaining.

(7) Now the cost, producing a video ad can be very expensive. FilmBox has fixed that problem too. Although FilmBox is much more powerful than typical television commercials, its cost is much less and the advertiser knows that he or she is getting feedback. By using some of today's new technology and computer software we can fully film and produce a professional video ad for about $125-$150 dollars. We use simple, affordable digital video cameras and go to each business and film what ever they like spending only about 15 to 20 minutes in each establishment. The cameraperson then takes notes on what the owner of the business wants in their ad and brings it back to the editor who uses powerful video editing software that is easy to use. The voiceover employees then usually write the script and do the voice with the editor. He or she can usually do five-ten ads an hour and the video editor can do an ad every one-two hours. The voice over person gets twenty dollars per ad and the editor gets twenty-thirty dollars per hour. The software does all the special effects and text; experienced editors are no longer necessary with today's software. Two weeks training is all that is needed. Even experienced editors are more than happy to receive twenty plus dollars per hour because there are so many people going to school for editing and so few jobs in their field. So now we have 18 commercials edited and burned to a DVD or Super VCD ready to go in the FilmBox. The customer pays only about $500 for production of their ad.

(8) Now depending on the establishment that houses the FilmBox, the ad will run continuously for a month. An establishment like Costco for example has approximately 20,000 people per month that will see the ad. Unlike television advertising, all of the 20,000 people will see it, thus eliminating the odds dramatically. One month of FilmBox airtime will run approximately $200 a month for 20,000 customers. That's five consumers that will see your ad for a penny. Not even a business card or flyer can be made for that price. Even the most affordable advertising in the world, Internet banner ads, cost the advertiser one penny per consumer and most consumers don't even look at those ads.

(9) FilmBox not only entertains the consumer in a boring situation. It has the ability to increase sales in the establishment that houses the FilmBox. The host, Costco for example, can run some of it's own inhouse ads on the Filmbox. It's distributors can also run ads. Normally there are products that don't sell well due to poor packaging or they are hard to explain without some kind of demonstration. However a demonstrator costs money. You have to pay a demonstrator to show your product while people are walking by. This greatly increases sales of the products and most companies are willing to spend five plus dollars for each potential consumer to see the demonstration. Even live demonstrations are not as effective as FilmBox because they clog isles, take up more space, and people can choose to just walk by and ignore the demonstrator. Only a hand full of people will actually take the time to stop and watch. With Filmbox a company can have its live demonstration on the box and every consumer will see it at a fraction of the cost. Another problem solved with FilmBox.

(10) So referring to the Background page 1-3 FilmBox has solved or improved upon all three problems related to advertising.

### DETAILED DESCRIPTION OF FILMBOX

Description: 7′8″ tall 16″ wide on all four sides. Aluminum frame made of ⅛″ aluminum L brackets and three flat 16″×16″, 16^{th} inch pans on the base, on the top, and in the middle of the box. The top pan holds a 6″fan that draws cooling air through the unit. The center pan holds the monitor or television (13″screen). On the outside of the aluminum frame is ⅛″ clear Plexiglas on three sides (front, left, and right sides.) On the back is a hinged, ¼″ thick door made of black plastic. On each piece of Plexiglas is vinyl stickers resembling a filmstrip with the inserts left clear for poster advertising. On each side of the television monitor are business card and coupon holders as well as brochure holders on the outside of the back door. On the inside of the back door are two fluorescent lights—a 12″ round light at the top of the door and a 4′ light in the middle of the door. At the bottom of the door are vent holes to draw air from the bottom of the box through the top. There are two speakers facing outward just above the television monitor. The television is at eye level facing the front of the box on the second space from the top. There are a total of twenty-one spaces- one for the monitor, two for the business card holders, and eighteen for posters. The posters are taped to the inside of the Plexiglas then lit up with the fluorescent lights. At the bottom of the box, on the lower pan, is a DVD player/or computer hard drive to hold video commercials, play them, and repeat the commercials throughout the day. With each twenty-sixty second commercial a customer gets one lighted poster ad and use of the coupon/business cardholders. Connected to the DVD player/hard drive is the computer board that controls the unit making it virtually maintenance free. The board itself can be controlled from a laptop or Internet via modem. The board controls the times the unit turns on and off and the repeat functions on the DVD player. Video can also be uploaded to a hard drive through this board via laptop or Internet with a modem. All videos are recorded in DVD or Super VCD format using Ulead video editing software.

1. What I claim as my invention is a new advertising medium. Which solves most of the problems affiliated with today's forms of advertising. It is a decorative, maintenance free kiosk that uses modem digital video editing software. This unit is designed to be placed at checkout counters, office waiting areas, movie theater lobbies, or anywhere else a consumer would be essentially captive.
